(19) United States
(12) Patent Application Publication
(10) Pub. No.: US 2009/0218849 A1
(43) Pub. Date: Sep. 3, 2009

(54) TEMPERATURE-CONTROLLED CARGO STORAGE COMPARTMENT

(75) Inventor: Ernesto RUPAR, Frankfurt (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/395,317

(22) Filed: Feb. 27, 2009

(30) Foreign Application Priority Data
Feb. 29, 2008 (DE) 202008002920.1

(51) Int. Cl. B62D 33/04

(52) U.S. Cl. 296/182.1

(57) ABSTRACT

The object of the present invention pertains to a motor vehicle, a cargo space for a motor vehicle and a cargo storage compartment for a cargo space of a motor vehicle, wherein the cargo storage compartment is closed toward the outside and arranged behind a paneling of the cargo space that can be at least partially opened, and wherein the cargo storage compartment is realized such that its temperature can be controlled with the aid of temperature control means in order to provide a cargo storage compartment that can be heated and/or cooled.

### CROSS-REFERENCE TO RELATED APPLICATION

This application claims priority to German Patent Application No. 202008002920.1, filed Feb. 29, 2008, which is incorporated herein by reference in its entirety.

### TECHNICAL FIELD

The invention pertains to a cargo storage compartment for a cargo space of a motor vehicle. The invention also pertains to a cargo space for a motor vehicle. The invention furthermore pertains to a motor vehicle having a storage compartment for a cargo space of a motor vehicle.

### BACKGROUND

Storage spaces for different objects such as a spare tire, tools, an emergency reflective triangle and the like that are arranged underneath the floor of a cargo space are known from the prior art. For example, DE 202006010896 U1 discloses a storage space for a spare tire that is open or opened toward the top and recessed into the cargo area of the tail or trunk region of a motor vehicle, and the storage space is realized in the form of a trough with an interior having about vertically arranged side walls and a floor that is essentially arranged horizontally. In this case, the storage space has construction features suitable for the multifunctional utilization thereof. Among other things, this storage space features inserts for various devices such as, among other things, an ice chest.

However, an additional device is required for the transport of temperature-sensitive objects or objects to be temperature-controlled. The temperature cannot be controlled during the driving mode in this case.

The present invention therefore is based on at least the one objective of developing a device that makes it possible to transport objects that can be easily temperature-controlled over longer distances, and the temperature can also be controlled while driving. Another objective of the present invention is to develop a motor vehicle with a corresponding storage compartment. In addition, other objectives, desirable features, and characteristics will become apparent from the subsequent summary and detailed description, and the appended claims, taken in conjunction with the accompanying drawings and this background.

### SUMMARY

In a cargo storage compartment for a cargo space of a motor vehicle, in which the cargo storage compartment is closed toward the outside and arranged behind a paneling of the cargo space that can be at least partially opened, an embodiment of the invention includes the technical characteristic that the cargo storage compartment is realized such that its temperature can be controlled with the aid of temperature controller, which shall also be referred to as a temperature control means, in order to provide a cargo storage compartment that can be heated and/or cooled. The cargo storage compartment is preferably arranged underneath the floor of a cargo space, trunk or tail region of a motor vehicle. However, the paneling may have a lateral paneling such that the cargo storage compartment may be arranged behind a lateral paneling of the cargo space or underneath a floor of the cargo space. The cargo storage compartment is preferably arranged underneath a cargo space floor. In this case, the cargo storage compartment forms another storage space in addition to the already existing storage space of the cargo area, and the cargo storage compartment and the cargo space are separated from one another by the cargo space floor. Temperature control means are provided in order to control the temperature or climate of the cargo storage compartment. These temperature control means may consist of heat exchangers, heating devices, cooling devices, ventilating devices and the like.

In one inventive embodiment of the cargo storage compartment, it is proposed that the paneling is realized in the form of a cargo space floor that is arranged flush referred to a sill of the cargo space. Consequently, any edges between the cargo space floor and the cargo space opening that could interfere with the loading and unloading of the cargo space through the cargo space opening are eliminated. In addition, the cargo space floor can be pulled out so conveniently that access to the cargo storage compartment is realized.

In another embodiment of the cargo storage compartment, it is proposed that the cargo space floor features a hinged lid in order to ensure that the cargo storage compartment arranged underneath the cargo space floor can be accessed without having to remove the cargo space floor. Due to these measures, it is not necessary to move the entire cargo space floor in order to access the cargo storage compartment situated hereunder. A hinged lid makes it possible to easily swing open part of the cargo space floor in order to gain access to the section of the cargo storage compartment situated hereunder. It would also be possible to provide several hinged lids such that the cargo storage compartment can be accessed at several locations. A hinged lid for a cargo space floor makes it possible to realize any possible access to the storage compartment situated hereunder. For example, it is not absolutely imperative to provide a hinged hatch. On the contrary, it would also be conceivable to realize solutions with snap-fasteners, zippers, sliding units, Velcro fasteners and the like.

According to another embodiment of the present invention, it is proposed that the temperature control means are integrated into the motor vehicle temperature control means and/or realized in the form of separate temperature control means. An integration of the temperature control means into the motor vehicle temperature control means makes it possible to control the temperature of the cargo storage compartment with the motor vehicle temperature control means. The term motor vehicle temperature control means includes all temperature control means provided in a motor vehicle such as a heater, a fan heater, a seat heater, a fan, an automatic climate control, an air-conditioning system and the like. For example, temperature control outlets may extend into the cargo storage compartment. The temperature of the cargo storage compartment may be controlled in dependence on the temperature control of the motor vehicle. However, the temperature control of the cargo storage compartment may also be realized independently thereof. The temperature of the cargo storage compartment can be individually adjusted by means of a control unit. Temperature sensors may be arranged in the cargo storage compartment in order to control and/or regulate the temperature. If the temperature control means are realized in the form of separate temperature control means, they can be easily exchanged, if so required, and stored outside the motor vehicle when they are not used. It would also be possible to realize a combination of integrated and separate temperature control means, and these temperature control means may once again be controlled by means of a common control unit.

In another embodiment of the present invention, it is proposed that the temperature control means comprise at least one heating element for heating the cargo storage compartment and at least one cooling element for cooling the cargo storage compartment. This makes it possible to arrange and transport objects that can or need to be kept warm or heated in a temperature-controlled fashion in the cargo storage compartment. For example, it would also be possible to transport shoes, ski boots, garments and the like in the cargo storage compartment such that they have a suitable temperature during the transport and when they are removed.

In another embodiment, it is proposed that the temperature control means comprise at least one cooling means for cooling the cargo storage compartment. This makes it possible to arrange and transport objects that can or need to be kept cold or cooled in a temperature-controlled fashion in the cargo storage compartment. For example, foods and the like can also be transported in the cargo storage compartment such that they have a suitable temperature during the transport and when they are removed.

In another embodiment, it is proposed that the temperature control means comprise at least one insulation, particularly a thermal insulation, in order to realize an energy-saving temperature control of the cargo storage compartment. The thermal insulation is realized in such a way that essentially no thermal energy is unintentionally conducted from/to the cargo storage compartment. If the cargo storage compartment needs to perform a cooling task at cool outside temperatures, the cool outside air of the surroundings can be used for this purpose. This applies analogously to a heating task to be performed at warm outside temperatures. If a heating task needs to be performed at cool outside temperatures or a cooling task needs to be performed at warm outside temperatures, the insulation is realized, in contrast, such that no thermal energy is unintentionally lost. It would also be possible to provide insulation against light, odors and the like such that, for example, no light is incident on light-sensitive objects or no odors penetrate into the motor vehicle interior.

According to another embodiment of the inventive cargo storage compartment, the insulation, particularly the thermal insulation, is realized such that it is integrated into at least one wall that defines the cargo storage compartment. Such walls include bottom walls, side walls and top walls. The top wall may be integrated into the cargo space floor or realized separately thereof. It is preferred to realize all wall sections with a corresponding insulation.

In another embodiment, it is proposed that the temperature control means comprise at least one ventilation opening in order to realize a suitable air circulation for the cargo storage compartment. A suitable climate control can be achieved in this fashion. In addition to realizing an air circulation, the at least one ventilation opening may also serve for supplying warm or cold air to the cargo storage compartment such that its temperature can be correspondingly controlled by means of the ventilation opening. The ventilation opening may be coupled to the ventilation openings of the motor vehicle. At least one ventilation opening can preferably be regulated in order to control the quantity of air to be supplied or discharged.

In one embodiment of the present invention, it is proposed that a drain is provided in one wall of the cargo storage compartment. This drain serves, for example, for draining cleaning water and/or melt water and the like. The drain is preferably arranged at a low point or the lowest point (i.e., the point arranged nearest the geocenter) of the cargo storage compartment or, in other words, in the bottom wall. The drain can be closed such that liquids can also be transported in a temperature-controlled fashion in the cargo storage compartment. Corresponding units such as hoses and the like can be attached to the drain, for example, with the aid of threads. The drain can also be used as an inlet in connection with a pump. Several drains can be provided. Likewise, inlets may also be provided.

In another embodiment of the inventive cargo storage compartment, it is proposed that the wall consists of a wear-resistant material. The wall may be subjected to external environmental influences such as splash water, exhaust gases, shocks and the like. Fluids may act upon the inside of the wall. Consequently, the wall needs to be manufactured of a wear-resistant material. Examples of such materials are plastics, metals, compounds, alloys, composite materials and the like. The material preferably consists of a material that is suitable for series production.

According to another embodiment, it is proposed that the cargo storage compartment is designed for accommodating objects that can be temperature-controlled before, during and/or after their use and/or transport such as winter sports equipment, foods and the like. This is the reason why corresponding holding devices are provided. These holding devices may be permanently installed or realized such that they can be inserted. Holding devices are provided, in particular, for ski boots, helmets, skis, bindings, sleds, bobsleds or corresponding parts thereof, beverages, foods and the like. The holding devices may be coupled to the temperature control means in such a way that, for example, the temperature control means are integrated into the holding devices.

In a cargo space for a motor vehicle, an embodiment of the invention also includes the technical characteristic that the cargo space comprises at least one inventive cargo storage compartment that is arranged underneath the cargo space floor that can be at least partially removed. The cargo space may consist of any trunk of a motor vehicle, the bottom of which ends with a cargo space floor. A cargo storage compartment is arranged underneath the cargo space floor. In order to access the cargo storage compartment, the cargo space floor can be at least partially removed, namely either as a whole or in sections.

In a motor vehicle, particularly a passenger car, an embodiment of the invention last but not least includes the technical characteristic that the motor vehicle comprises an inventive cargo space. The motor vehicle may consist of any type of motor vehicle such as station wagons, vans, minivans, sedans, coupes, sports cars, off-road vehicles, convertibles, buses, transporters and the like. The cargo storage compartment can be subsequently installed or directory integrated into the motor vehicle.

### BRIEF DESCRIPTION OF THE DRAWINGS

The present invention will hereinafter be described in conjunction with the following drawing figures, wherein like numerals denote like elements, and:

FIG. 1 shows a perspective representation of a motor vehicle with a cargo space featuring an inventive cargo storage compartment;

FIG. 2 shows a perspective representation of a sectionally illustrated detail of the cargo space that features an inventive cargo storage compartment; and

FIG. 3 shows a perspective representation of a motor vehicle with closed cargo storage compartment.

### DETAILED DESCRIPTION

The following detailed description is merely exemplary in nature and is not intended to limit application and uses. Furthermore, there is no intention to be bound by any theory presented in the preceding background or summary or the following detailed description.

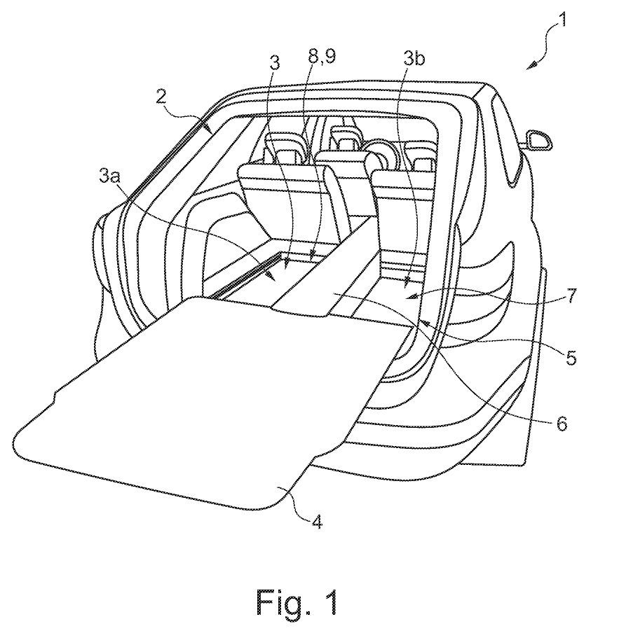

FIG. 1 shows a perspective representation of a motor vehicle 1 with a cargo space 2 that features a cargo storage compartment 3 in accordance with an embodiment of the invention. The cargo storage compartment 3 is arranged underneath the cargo space 2 and separated there from by a cargo space floor 4, which is removable, that is arranged flush with a sill in this case. The cargo space floor 4 is realized in a plate-shaped fashion and can be removed from the motor vehicle 1 along guides 5. In the embodiment shown, the cargo storage compartment 3 comprises two storage compartments 3a, 3b that are separated by an intermediate element 6. The cargo storage compartment 3 is defined by walls 7 that also include the cargo space floor 4. The temperature control means 8 that are illustrated in the form of ventilation openings 9 in this case are integrated into the walls 7. In the embodiment shown, the cargo storage compartment 3 is designed for accommodating winter sports equipment consisting of skis, ski boots, snowboards, helmets and the like. In this case, it is also possible to merely accommodate individual equipment parts in the cargo storage compartment 3.

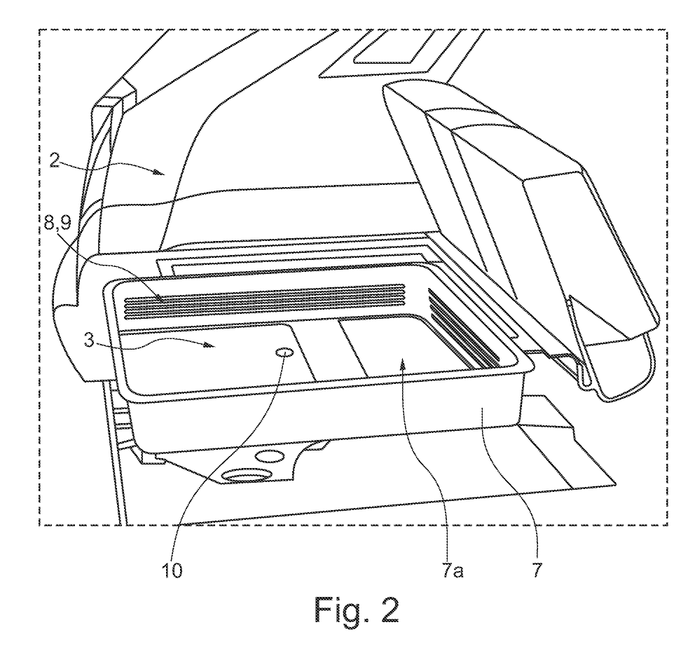

FIG. 2 shows a perspective representation of a sectionally illustrated detail of the cargo space 2 that comprises the cargo storage compartment 3 as previously described in this detailed description. The cargo storage compartment is recessed relative to and arranged underneath the floor of the cargo space 2. The top of the cargo storage compartment 3 is defined by the cargo space floor 4 that is removed in this figure. The remaining walls 7 are realized in the form of a trough. Temperature control means 8 in the form of ventilation openings 9 are arranged in the walls 7 in order to convey warm and/or cold air into the cargo storage compartment 3. A drain 10 is inserted into a bottom wall 7a of the cargo storage compartment 3. This drain is realized such that it can be closed. The drain makes it possible to remove, for example, cleaning water or melt water from the cargo storage compartment 3.

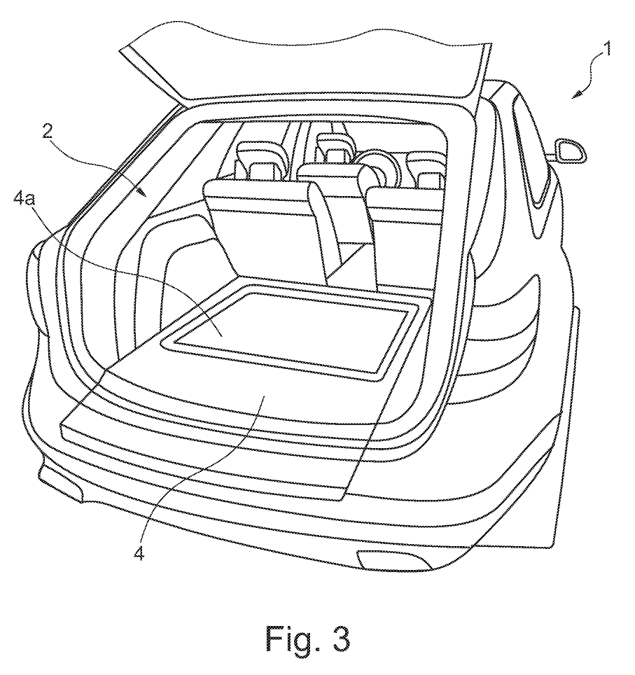

FIG. 3 shows a perspective representation of a motor vehicle 1 with cargo storage compartment 3 in a closed configuration. In this case, the cargo space floor 4 is pushed in and separates the cargo storage compartment 3 (that is not visible in this figure) from the cargo space 2 of the motor vehicle 1. The cargo space floor 4 contains a hinged lid 4a in order to gain access to the cargo storage compartment 3 that is covered by the cargo space floor 4. The hinged lid 4a is designed such that it can be pivoted on the cargo space floor 4 and makes it possible to gain access to the cargo storage compartment 3 without having to remove the entire cargo space floor 4, namely by pivoting back the hinged lid.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A cargo storage compartment for a cargo space of a motor vehicle, comprising:
a paneling of the cargo space that can be at least partially opened and for which the cargo storage compartment is closed toward an outside and arranged behind; and
a temperature controller adapted to control a temperature of the cargo storage compartment.

2. The cargo storage compartment according to claim 1, wherein the paneling comprises a cargo space floor that is realized substantially flush with a sill of the cargo space.

3. The cargo storage compartment according to claim 2, wherein the cargo space floor comprises a hinged lid adapted to provide access to the cargo storage compartment without having to remove the cargo space floor.

4. The cargo storage compartment according to claim 1, wherein the temperature controller is integrated into a vehicle temperature of the motor vehicle.

5. The cargo storage compartment according to claim 1, wherein the temperature controller comprises at least one heating element for heating the cargo storage compartment.

6. The cargo storage compartment according to claim 1, wherein the temperature controller comprises at least one cooling element for cooling the cargo storage compartment.

7. The cargo storage compartment according to claim 1, wherein the temperature controller comprises an insulation.

8. The cargo storage compartment according to claim 7, wherein the insulation is at least partially integrated into at least one wall that defines the cargo storage compartment.

9. The cargo storage compartment according to claim 1, wherein the temperature controller comprises at least one ventilation opening adapted to provide air circulation for the cargo storage compartment.

10. The cargo storage compartment according to claim 1, further comprising a drain is provided in a wall of the cargo storage compartment.

11. The cargo storage compartment according to claim 10, wherein the wall is formed at least partially from a wear-resistant material.
